(19) United States
(12) Patent Application Publication
(10) Pub. No.: US 2019/0199178 A1
(43) Pub. Date: Jun. 27, 2019

(54) ELECTRICAL MACHINE

(71) Applicant: VALEO SIEMENS EAUTOMOTIVE GERMANY GMBH, Erlangen (DE)

(72) Inventors: Martin KUHN, Roth (DE); Silvio ZAMZOW, Beinerstadt (DE)

(21) Appl. No.: 16/328,480

(22) PCT Filed: Aug. 31, 2017
(86) PCT No.: PCT/EP2017/071905

§ 371 Date: Feb. 26, 2019

(30) Foreign Application Priority Data
Sep. 1, 2016 (DE) 10 2016 216 480.5

(51) Int. Cl. H02K 11/225; G01D 5/244; G01D 5/20; H02K 15/00

(52) U.S. Cl. CPC H02K 11/225; H02K 15/00; G01D 5/204; G01D 5/24442

(57) ABSTRACT

The invention relates to an electrical machine, includes a rotatable shaft extending in a longitudinal direction, a rotor which is rotationally fixed on the shaft, and a resolver which includes a resolver rotor and a resolver stator in order to detect the angular position of the rotor, the resolver rotor being non-rotatably connected to the rotor disposed on the shaft.

The invention relates to an electrical machine.

An electrical machine, such as an electric motor or a generator, in general comprises a stator which is provided with a field coil and in which a rotor comprising one or more permanent magnets is mounted rotatably about the rotor axis. The rotor is connected to a shaft, whereby torque is transmitted between the shaft and the rotor.

A resolver is typically used to detect the rotational speed or the rotational position of the shaft of an electrical machine. The resolver comprises a resolver rotor and a resolver stator. The resolver rotor usually disposed offset from the rotor of the electrical machine, on the shaft. The shaft thus constitutes the connecting member between the rotor of the electrical machine and the resolver rotor.

The transmission of torque between a rotor and a shaft at present usually takes place in a force-fit manner by way of transverse interference fit between the two components of the electrical machine. The problem with such transverse interference fit, however, is the mechanical stress that is introduced into the rotor by the press fit. Moreover, an additional stress component is generated during operation of the electrical machine by the centrifugal force caused during the rotation of the shaft.

The mechanical stress introduced by the press fit is reduced by the centrifugal force during operation of the electrical machine, which is to say during rotation of the shaft. However, as a result of the combination of the two stress components, the overall material stress is increased up to the permissible material yield point, which is considered the limit of the maximum possible rotational speed.

One alternative to a force-fit attachment is a form-locked joint between the rotor of the electrical machine and the shaft. A combination of form fit and force fit for attaching the rotor on the shaft is also possible. Form-locked joints include flattened regions, grooves or polygonal splines, for example. However, due to the high manufacturing costs and possible shifting of the relative rotor positions of the resolver rotor with respect to the rotor of the electrical machine, a form-locked attachment represents a design challenge. A rotational error of the resolver rotor with respect to the rotor of the electrical machine can result in incorrect power application to the electrical machine and, in the worst-case scenario, in the failure thereof.

Accordingly, at present it is therefore always necessary to take the respective preload or the “initial damage” of the stress field into consideration in the design of the maximum rotational speed. When the rotational speed is reduced, the initial stress of the rotor of the electrical machine is also reduced. At the same time, a possible rotation of the motor rotor has to be considered in such a reduction. Form-locked joints tolerate a slight rotation of the motor rotor, which the supplier then attempts to minimize with narrow tolerance zones and accordingly high manufacturing costs.

It is an object of the invention to provide an option by way of which the position of a motor rotor of an electrical machine can be correctly detected.

This object of the invention is achieved according to the invention by an electrical machine, comprising a rotatable shaft extending in a longitudinal direction, a rotor disposed on the shaft in a form-locked manner, and a resolver comprising a resolver rotor and a resolver stator for detecting the angular position of the rotor, wherein the resolver rotor is non-rotatably connected to the rotor disposed on the shaft.

The invention seeks to reduce the press stress of the force-fit transverse interference fit between the rotor and the shaft at maximum rotational speed. In principle, this can be achieved when the torque transmission between the rotor of the electrical machine and the shaft takes place at least partially by way of the form-locked joint thereof.

Such torque transmission can be achieved, for example, by shafts having polygonal outer contours. According to the present state of the art of rotational technologies, these can be produced in an essentially cost-neutral manner compared to shafts having a circular cross-section. In the case of an accordingly designed shaft, the torque transmission is ensured in part by way of the press-fit and in part by way of the form fit between the rotor of the electrical machine and the shaft.

However, when using a shaft configured in this way, the expansion of the rotor of the electrical machine results in angular rotation at high rotational speeds. This relative rotation of the motor rotor with respect to the shaft cannot be detected by the resolver in the case of the common system design.

Taking the above-described problem into consideration, the invention in a third step identifies that faulty measurements or determinations of the rotor position of an electrical machine which are based on rotation errors can be avoided, even at high rotational speeds, when the rotor of the electrical machine and the resolver rotor cannot be rotated relative to one another. Such a relative movement, which can cause a distorted position determination of the rotor of the electrical machine, is suppressed by coupling the position of the motor rotor to the position of the resolver rotor. For this purpose, the resolver rotor is non-rotatably connected to the rotor of the electrical machine disposed on the shaft.

In this way, the position measurement of the rotor motor is also carried out correctly in the case of an angular rotation of the motor rotor on the shaft. Small angular deviations as a result of reduced fits, and optionally due to polygonal contours, can be compensated for.

It is advantageous when the shaft is designed such that a form-locked joint is established between the rotor and the shaft by way of a spline, flattened regions or grooves. It is particularly preferred when the shaft is designed with a polygonal outer contour. The form fit between the rotor of the electrical machine and the shaft is ensured by way of this polygonal outer contour. A polygonal cross-section can be competitively produced compared to circular cross-section in terms of the manufacturing costs.

In a particularly advantageous embodiment of the invention, the resolver rotor is connected to and spaced apart from the rotor of the electrical machine in the longitudinal direction. The spacing is achieved by an adapter or a spacer. Pins or webs can be used as possible adapters, which are each oriented parallel to the longitudinal direction of the shaft and non-rotatably connect the rotor of the electrical machine to the resolver rotor.

As an alternative, the resolver rotor is preferably connected directly to the rotor. Such an arrangement is preferred, in particular, in electrical machines that are designed as synchronous machines and comprise permanent magnets. The use of an adapter or of a spacer between the resolver rotor and the rotor of the electrical machine is not necessary.

The resolver stator is advantageously fixed to the housing. In other words, the resolver stator is non-rotatably attached to a housing. The attachment is advantageously carried out to the housing of the electrical machine. The resolver rotor and thus the shaft have a defined rotational position with respect to the resolver stator.

The electrical machine preferably comprises a stator that is fixed to the housing, wherein the rotor of the electrical machine can be rotated relative to the stator. The resolver stator is preferably disposed in a stationary manner with respect to the stator of the electrical machine which is fixed to the housing.

The rotor of the electrical machine is, in particular, designed as a lamination stack comprising a plurality of sheets layered in the longitudinal direction. The sheets are advantageously produced individually, stacked axially, and thereafter joined to one another so as to form a lamination stack. It is advantageous when the sheets are bonded or welded to one another to form the lamination stack.

In principle, electrical machines are divided into rotating and static electrical machines. Rotating electrical machines or rotating machines include electric motors, which are, in turn, divided into direct current, alternating current and three-phase motors, as well as generators. In contrast, transformers form part of the group of static electrical machines. The electrical machine is particularly preferably designed as an electric motor.

Exemplary embodiments of the invention will be described hereafter in greater detail based on a drawing. In the drawings:

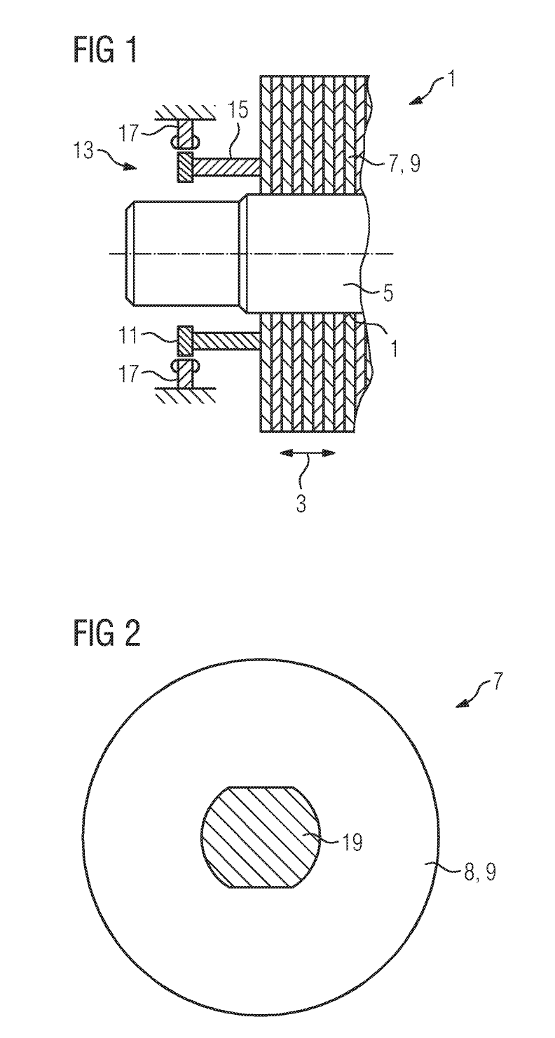

FIG. 1 shows a detail of an electrical machine comprising a rotor, which is attached on a shaft, and a resolver rotor, which is rotationally fixed on the rotor; and

FIG. 2 shows the rotor according to FIG. 1 in a cross-sectional view.

FIG. 1 shows a detail of an electrical machine 1 designed as an electric motor. The electrical machine comprises a shaft 5 which extends in a longitudinal direction 3 and on which a rotor 7 is disposed in a form-locked manner. The rotor 7 of the electrical machine is designed as a lamination stack 8 comprising a plurality of sheets 9 layered in the longitudinal direction 3.

The electrical machine furthermore comprises a stator (not shown here) that is fixed to the housing. The rotor 7 is disposed relative to the stator rotatable therein.

A resolver rotor 11 of a resolver 13 is non-rotatably connected to the rotor 7 of the electrical machine 1. The resolver 13 is used to detect the angular position of the rotor 7. In the present example, the resolver rotor 11 is connected to and spaced apart from the rotor 7 in the longitudinal direction 3. For this purpose, an adapter 15 in the form of a web is used, which non-rotatably attaches the resolver rotor 11 and the rotor 7 of the electrical machine 1 to one another.

This arrangement of the rotor resolver 11 on the rotor 7 of the electrical machine 1—and not, as is otherwise customary, on the shaft 5—does not allow the two components 7, 11 to be moved relative to one another. The position of the rotor 7 of the electrical machine 1 is coupled to the position of the resolver rotor 11.

In this way, the position the rotor 7 can also be determined out correctly in the case of an angular rotation of the rotor 7 on the shaft 5. Small angular deviations due to reduced fits and contours so as to create form-locked joints are appropriately compensated for.

The resolver 13 likewise comprises a resolver stator 17, which in the present example is disposed on the housing 19 of the electrical machine 1. Furthermore, the resolver stator 17 is disposed in a stationary manner with respect to the stator of the electrical machine 1.

FIG. 2 shows the rotor 7 of the electrical machine 1 in a cross-sectional view. The rotor 7 is composed of a plurality of layered sheets 9 that are joined to one another to form the lamination stack 8. The rotor 7 comprises a receptacle 19 by way of which it is connected to the shaft 5. The shaft 5 is pushed into the receptacle 21 of the rotor 7 for this purpose, or the rotor 7 is pressed onto the outer circumference 21 of the shaft 5. Thanks to the rotationally fixed arrangement of the rotor resolver 11 on the rotor 7 of the electrical machine 1 when assembled, the position of the rotor 7 is also reliably determined in the case of a rotation thereof on the shaft 5. The rotation of the rotor is reversibly dependent on the operation of the electrical machine 1.

1. An electrical machine, comprising a rotatable shaft extending in a longitudinal direction, a rotor that is rotationally fixed on the shaft, and a resolver comprising a resolver rotor and a resolver stator for detecting the angular position of the rotor, wherein the resolver rotor is non-rotatably connected to the rotor disposed on the shaft.

2. The electrical machine according to claim 1, wherein the resolver rotor is connected to and spaced apart from the rotor in the longitudinal direction.

3. The electrical machine according to claim 1, wherein the resolver rotor is connected directly to the rotor.

4. The electrical machine according to any one of the preceding claims claim 1, wherein the resolver stator is fixed to the housing.

5. The electrical machine according to any one of the preceding claims claim 1, comprising a stator that is fixed to the housing, wherein the rotor can be rotated relative to the stator.

6. The electrical machine according to claim 5, wherein the resolver stator is disposed in a stationary manner with respect to the stator.

7. The electrical machine according to claim 1, wherein the rotor thereof is designed as a lamination stack comprising a plurality of sheets layered in the longitudinal direction.

8. The electrical machine according to claim 1, wherein the rotor and the shaft are connected to one another in a form-locked manner.

9. The electrical machine according to claim 1, wherein the electrical machine is an electric motor.
